(19) United States
(12) Patent Application Publication
(10) Pub. No.: US 2009/0017795 A1
(43) Pub. Date: Jan. 15, 2009

(54) METHOD FOR ENHANCING SERVICES CONCERNING MULTIMEDIA DATA IN MOBILE TELEPHONY

(75) Inventors: Frederic Guichard, Paris (FR); Bruno Liege, Boulogne (FR); Jerome Meniere, Paris (FR)

Correspondence Address: OBLON, SPIVAK, MCCLELLAND MAIER & NEUSTADT, P.C., 1940 DUKE STREET, ALEXANDRIA, VA, 22314, US

(73) Assignee: DXO LABS, Boulogne Billancourt (FR)

(21) Appl. No.: 11/628,712

(22) PCT Filed: Jun. 8, 2005
(86) PCT No.: PCT/FR2005/050430

§ 371 Date: Aug. 22, 2008

(30) Foreign Application Priority Data
Jun. 8, 2004 (FR) 0451132

(51) Int. Cl. H04Q 7/22

(52) U.S. Cl. 455/414.1

(57) ABSTRACT

A method for enhancing quality of use of at least one service concerning at least one multimedia data, in particular concerning photographs, video, audio, and/or text. The method includes automatically implementing before and/or during and/or after acquiring the multimedia data functions of the terminal required for the service. The automatic implementation of functions of the terminal including selecting, among the functions available in the terminal, functions required for the service, automatically and/or manually setting up by the user, of at least one scenario suited to the service, the scenario including logically concatenated sequences of the selected functions. The method further, for the user, selects a specific scenario among the previously set up scenarios.

The invention relates to a method to improve the quality of using at least one type of multimedia data, such service being proposed by a service provider and/or a telecommunications' operator by way of a mobile telephone terminal.

The invention also concerns a mobile telephone terminal implementing such method.

By “multimedia data” is meant here photographs, drawings, text, video, audio, audiovisual or programmes.

The invention results from the observation that the use of mobile telephone terminals lacks design when having to call up such service. For example, when using a mobile telephone terminal equipped with a picture-taking device and a user wishes to send photos taken via MMS, it is necessary to perform several operations or functions one after the other.

Thus in order to improve the user design of at least one service relating to at least one type of multimedia data, such service being proposed by a service provider and/or a telecommunications' operator by way of a mobile telephone terminal, the method comprising, according to the invention, the automatic implementation, prior to and/or during and/or after acquiring the multimedia data, several terminal functions necessary to the service, such automatic implementation of the terminal functions including the following steps:

selecting, among the available functions inside the terminal, the functions necessary to the service,

preparing, automatically and/or manually, by the user, at least one scenario adapted to the service, such scenario including logical chain sequences for the selected functions,

the method further including the step, for the user, to choose a determined scenario from among the scenarios previously prepared.

By “function” is meant an element included in the group comprising:

the choice of a service,

the guiding of a user, particularly assistance to acquire a type of multimedia data,

acquiring multimedia data,

verifying the quality of the multimedia data,

searching for multimedia data,

retouching or modifying the multimedia data,

processing the multimedia data,

improving the quality of the multimedia data, particularly the quality of an image,

combining multimedia data, namely texts and images for a postcard,

compressing the multimedia data, particularly in accordance with the network specifications,

choosing a template,

presenting multimedia data page layout,

keying in an address or a choice inside the base of recipients,

sending and/or transmitting and/or guiding the multimedia data across a network,

receiving multimedia data.

By “template” is meant data that is based on a previous usage of the service provided, or being provided, or received or saved by the user inside his/her terminal in a so-called “preferences” file. For example, for a service to send postcards using a mobile telephone terminal or for sending an e-mail, the template constitutes all or part of an e-mail or a postcard already created, sent and received or saved.

In an embodiment, the user is guided by way of a terminal interface which shows the accessible services to the user via such terminal.

According to an embodiment, at least one part of the scenario is pre-recorded, for example during a previous use of the service.

According to an embodiment, the specifications of the multimedia data are automatically determined according to the selected service.

When the multimedia data is an image, the characteristics of such image, which are automatically determined according to the service selected, are picture-taking parameters. For example, an image destined to a mobile telephone shall benefit from a longer exposure time than an image destined to a printing service or to be displayed on a computer screen, seeing as an image on a small-size screen, such as that of a mobile telephone terminal is a lot less sensitive to the movement blur than an image of large dimensions.

According to an embodiment in which the multimedia data is also an image, the latter is acquired in order to provide at least two services, and the characteristics of this image are the picture-taking parameters, which are determined automatically according to at least one of the two services and to the amount of lighting during picture-taking, so that, in particular, in low lighting, the image can be used for at least one of the two services.

In an embodiment, at least two types of multimedia data are acquired for providing at least two services, the specifications of each multimedia data being adapted to the corresponding service.

For example, it is possible to produce two images of a same subject of which the characteristics differ depending on the image's use or the image's end use.

Such facility can be used in a general manner inside an image acquisition device in which can be selected the use of the image or the end use of the image, and the picture-taking parameters are automatically selected according to the image's use or to the end use.

For example, such image acquisition device comprises the possibility to simultaneously take a picture of a subject destined for printing using a determined format, such as 10×15 cm, and an image of the same subject using full resolution.

Under such conditions, if for example the image acquisition device enables a resolution of 6 million pixels, the image in full resolution shall of course be taken with 6 million pixels, while the image destined for printing in 10×15 format could be taken using a resolution of 2 million pixels. The reduction in resolution can be an advantage for improving other characteristics. For example, the exposure time can be reduced, which reduces the effect of any possible movement. For example, the processing time being generally proportional to the number of pixels, the reduction in resolution enables to free up a greater amount of IT performance for reducing the noise in low lighting and extending the range of use in low lighting. As a general manner, adapting the picture-taking parameters to the end use enables to choose parameters which can cause invisible or hardly visible defects and to select, as compensation, parameters enabling to improve the image.

Such facilities can be used independently from those defined above, relating to improving the quality of using a service proposed by a service provider and/or a telecommunications' operator for use of a mobile telephone terminal.

According to an embodiment, the method includes, for implementing the service, the step for searching for a type of multimedia data pre-recorded inside the terminal.

According to an embodiment, the method includes the step for choosing a presentation, or page layout, for the multimedia data, for example, by using a template and/or a presentation parameter.

In an embodiment, the method includes the step for providing automatic assistance to the terminal's user in order to carry out an acquisition of the multimedia data, namely by helping with the image framing and/or with verifying the quality of such image, by providing lessons or instructions for acquisition and/or for adjustment, or by displaying the final result of the acquisition.

According to an embodiment, the method includes the step for modifying the multimedia data.

In to an embodiment, the method includes the step for processing the multimedia data either locally, i.e. inside the terminal, or remotely, i.e. outside of the terminal, namely inside a server.

According to an embodiment, the method includes the step for choosing a recipient, for example using a link with an address book and/or automatic input.

According to an embodiment, the method includes the step for compressing the multimedia data depending on at least one specification of the network relating to its transmission output.

According to an embodiment, the method includes the step for inserting a type of multimedia data relating to text inside a type of multimedia data relating to an image, known as a “postcard”.

According to an embodiment, the method includes the step for transmitting a type of multimedia data relating to an image using at least one of the following means of communication: facsimile, telephone, e-mail.

According to an embodiment, the method includes the step for managing a user's personal album of multimedia data, such album being stored in a server accessible to the terminal via the telecommunications' network.

According to an embodiment, the method includes the step for transmitting the multimedia data towards a printing service, such as a printer.

The invention also concerns a mobile telephone terminal wherein, in order to improve the quality of use of at least one service relating to at least one type of multimedia data, namely relating to photographs, video, audio and/or text, such service being proposed by a service provider and/or a telecommunications' operator, which includes means for automatically implementing, prior to, during and/or after the acquisition of the multimedia data, several functions of the terminal necessary to the services, such means include:

a means for selecting, from among the functions available inside the terminal, the functions necessary to the services,

a means for automatically and/or manually preparing at least one scenario adapted to the service, such scenario being composed of selected logic chain sequences for the functions selected, and

a means enabling the user to choose a determined scenario from among the scenarios previously prepared.

In an embodiment, a guiding interface presents the services accessible to the user.

According to an embodiment, the terminal includes means for recording a part of the scenario.

In an embodiment, the terminal includes means for automatically determining the specifications of the multimedia data depending on the service selected. In such a case, when the multimedia data is an image, the means for automatically determining the image characteristics include a means for automatically determining the picture-taking parameters depending on the service, so that, for example, an image destined to a mobile telephone can benefit from a longer exposure time than an image destined to a printing service or to be displayed on a computer screen.

According to an embodiment, the terminal includes means for acquiring an image for the purpose of providing at least two services, and a means so that the characteristics of this image are the picture-taking parameters, which are determined automatically according to at least one of the two services and to the amount of lighting during the picture taking, so that, particularly in low lighting, the image can be used for at least one of the two services.

According to an embodiment, the terminal includes a means for acquiring at least two types of multimedia data for providing at least two services, and for adapting the specifications of each multimedia data to the corresponding service.

According to an embodiment, the terminal includes a means for searching for a type of multimedia data pre-recorded inside the terminal in order to implement the service.

According to an embodiment, the terminal includes a means for choosing a presentation or a page layout for the multimedia data, for example by using a template and/or a presentation parameter.

According to an embodiment, the terminal includes means for providing automatic assistance to the terminal's user in order to perform an acquisition of the multimedia data, namely by helping with the image framing and/or with verifying the image quality, by providing lessons or instructions for acquisition and/or adjustment, or by displaying the final acquisition result.

According to an embodiment, the terminal includes a means for modifying the multimedia data.

According to an embodiment, the terminal includes means for processing the multimedia data, either locally, i.e. inside the terminal, or remotely, i.e. outside the terminal.

According to an embodiment, the terminal includes means for choosing a recipient, for example by using a link with an address book and/or automatic input.

According to an embodiment, the terminal includes a means for compressing the multimedia data according to at least one network specification relating to its transmission output.

According to an embodiment, the terminal includes a means for inserting a multimedia data relating to text inside a type of multimedia data relating to an image, known as “postcard”.

According to an embodiment, the terminal includes a means for transmitting a type of multimedia data relating to an image by using at least one of the following means of communication: facsimile, telephone, e-mail.

According to an embodiment, the terminal includes a means for managing a user's personal album of multimedia data, such album being stored in a server accessible to such terminal via the telecommunications' network.

According to an embodiment, the terminal includes a means for transmitting the multimedia data towards a printing service, such as a printer.

Other characteristics and advantages of the invention shall come to light in the description of some of its methods of embodiment, these being performed by referring to the sketches attached hereto whereby:

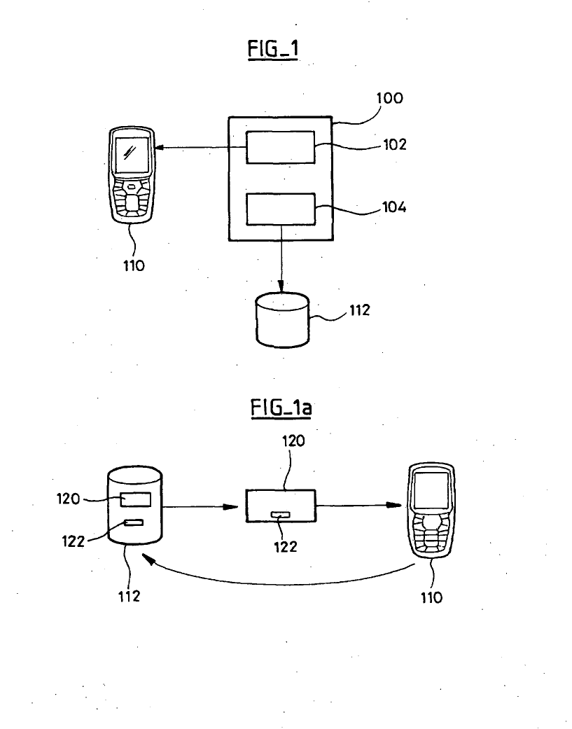

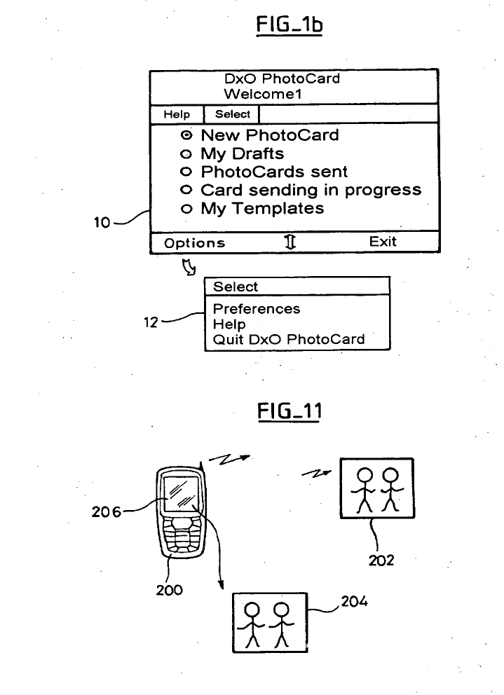

FIGS. 1 and 1a illustrate the steps of a method according to the invention,

FIGS. 1b, 2a, 2b, 2c, 3, 4, 5, 6, 7 and 8 illustrate a method according to the invention applied to the sending of postcards,

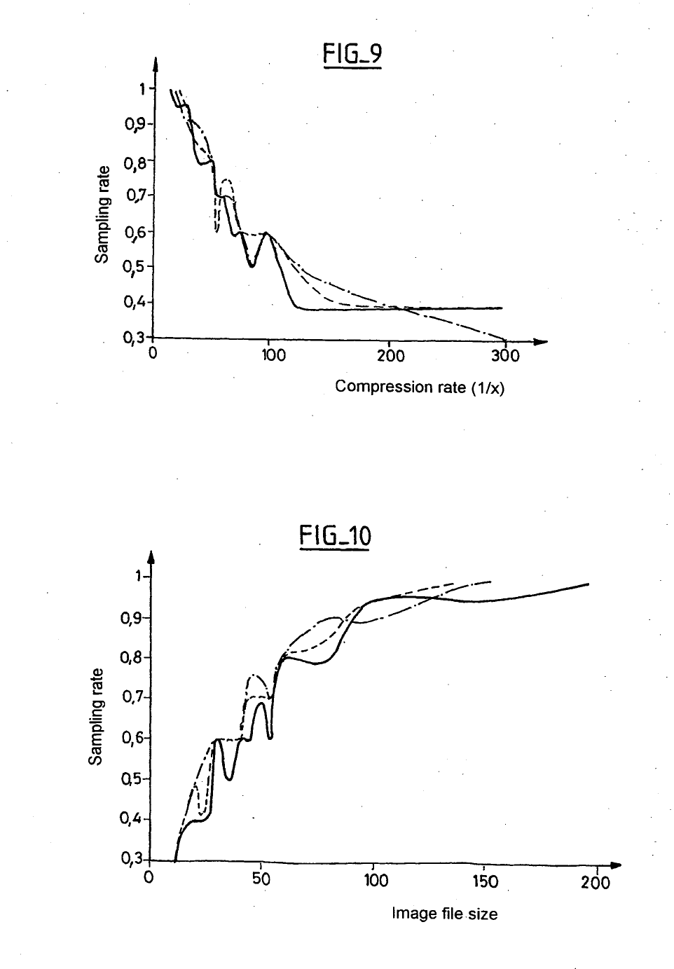

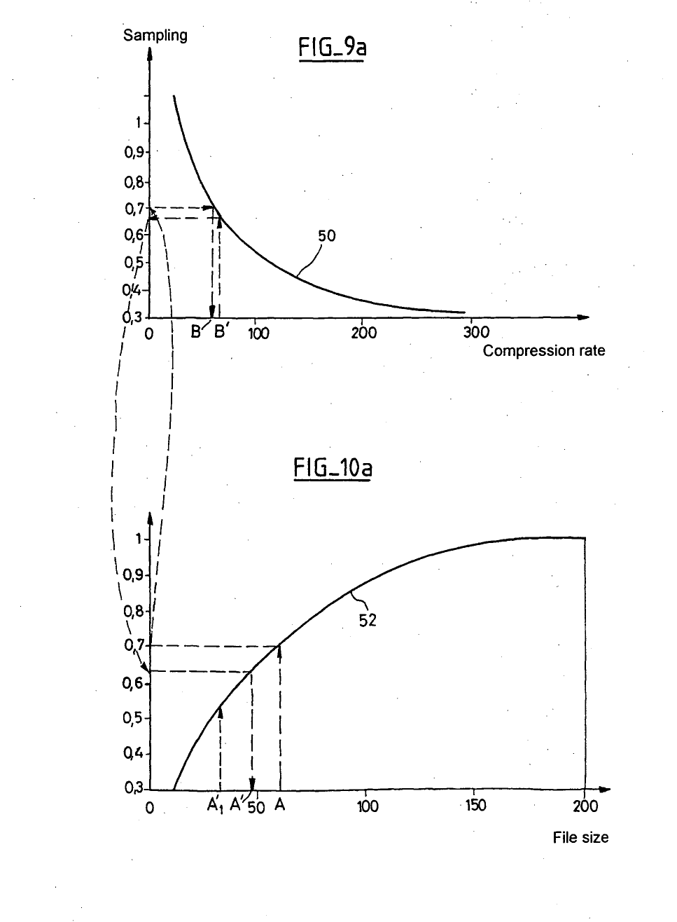

the curves in FIGS. 9, 10, 9a and 10a are charts enabling to choose, in compliance with the invention, a compression rate and a sampling rate, and

FIG. 11 is a sketch illustrating other steps of the method complying with the invention.

The examples described mainly refer to a mobile telephone terminal equipped with a picture-taking device, often known as a “photophone” or a “cameraphone”.

### Using the Services

Using such terminals is tedious, especially when it concerns:

configuring a telephone to send images (via MMS, WAP, etc.),

parametering a service for a provider; for example, in order to record for an on-line printing service, it is necessary to provide one's personal details, choose a pick-up point, etc.

keying in text to accompany the photo or an address: inputting text is rather time-consuming, the postal address is rarely incorporated in the address book, etc.,

using a service: it is often necessary to use several functions one after the other, such as taking a picture, retouching and sending; the design of the applications is more function-oriented (camera, MMS) rather than adapted to an image service; some operations thus take some time,

using the terminal in place of a camera.

### Image Quality

The image quality is limited due to the reduced dimensions, electricity consumption and mobile terminal costs.

The quality is variable depending on the terminal type and requires specific image processing. The image quality depends on the how the image is viewed. In particular, on a tiny screen many defects are invisible, while on a large-size screen or on a print-out, such defects become visible.

The images are highly compressed for the purpose of being stored inside the authorised pass-band, which produces artefacts during the decompression required for displaying or printing the images.

Thus we have particularly troublesome drawbacks which hinder the development of using photo services with a mobile telephone terminal due to such services being much less efficient than those linked to dedicated cameras.

### Architecture

The calculation time for improving images is generally proportional to the size of the image, i.e. to the number of pixels.

Improving the quality of the image takes up considerable calculation time and thus electricity. The capacity of the processors integrated into the terminals increases less quickly than the number of pixels from the detectors.

The IT performance is limited and varies according to the terminal type.

Access to the IT performance is variable depending on the terminal type: certain terminals accept code written in C++, some only accept Java code (much slower for image processing than C++), others are not open to coding.

The local storage capacity is limited.

The size of the transmission pipes is limited. In France, it corresponds to 50 ko per message, passing gradually to 100 ko.

Images transit systematically by a server for the various services.

In order to resolve these problems, the invention improves the image quality and/or improves the design for use.

The method according to the invention intervenes prior to taking a picture and/or during picture-taking and/or after taking a picture.

Thus, as illustrated in FIG. 1, starting from an image 100, or, more generally, from a type of multimedia data, shall be determined a first fraction 102 of such data which has to be processed inside the mobile telephone 110 and a second fraction 104 of the image 100 which has to be processed in a remote server 112.

As a variant, and as described hereafter in relation to FIGS. 1b to 8, the processing of all the multimedia data (or a part of it) shall be split up in order for a first fraction of the process to be performed inside the terminal 110 and for a second fraction of the process to be performed inside the server 112.

In the example shown in FIG. 1a, the multimedia data 120 is stored without additional compression or with additional low compression in the remote server 112. It is compressed for transmission to the mobile telephone 110. It also undergoes a process depending on the service to be provided to such telephone 110 or requested by such telephone 110. Furthermore, the data 120 is allocated a markup 122 linked to such data. Such markup is transmitted with the data of the server towards the terminal 110 in order to allow subsequent use of the same non-compressed original data 120 when it is required by the mobile terminal or another mobile terminal. In other words, when the mobile terminal receives an image and wants to transmit it to another mobile terminal, in order to prevent deterioration due to the compression and to successive decompressions, the multimedia data can retrieve its original quality in the server 112 by way of the markup.

### 1. Services

### 1.1. The Various Services Considered Using the Image Are:

Sending a facsimile from a terminal,

Sending towards another terminal,

Sending towards an e-mail,

Sending towards an on-line album,

Sending towards a personal Internet site (“moblog” in English),

Sending a postcard,

Sending a request for printing,

Sending a request for passport photos,

Requesting feedback onto the issuing terminal.

### 1.2. For Each One of the Services:

Taking a picture and/or searching in an album and/or retouching with improvement of the picture taken (lessons, framing assistance, verification, etc.),

the user design is improved,

the image quality is improved, as described below, by carrying out a local process and/or a process transferred towards a server,

a text photo is used where necessary (sometimes called “FotoText+”).

1.3. In Order to Send a Facsimile (Fax) from a Terminal, the Procedure is as Follows:

a picture is taken of a document containing the text and/or the drawings,

a background clean up is performed,
locally (in the terminal), or
remotely on a server with dispatch towards a fax machine,

text can be keyed in,

layout of the fax is possible,

it can be sent via MMS, WAP, http, etc., or directly from the terminal towards a fax machine, if the process is local.

In order to send a facsimile from a terminal, the following procedure is also possible:

Taking a picture of a document containing the text and/or the drawings,

Background clean-up process inside the terminal,

Possible text input,

Fax layout,

Sending via MMS, WAP, http, etc. towards a server or directly from the terminal towards a fax machine.

In order to send a facsimile from a terminal, it is also possible to use another procedure:

Taking a picture of a document containing the text and/or the drawings,

Possible text input,

Sending via MMS, WAP, http, etc. towards a server,

Background clean-up process inside the terminal,

Fax layout,

Dispatch towards a fax machine.

### 1.4. A Passport Photo Service Includes, in the Embodiment, the Following Steps:

Picture-taking with framing assistance.

Such framing assistance can be adapted to country standards for official documents.

The framing assistance enables to segment the image in order to more easily carry out the check points below.

Verifying compliance with the rules:

The rules which can be verified are, for example:

checking for a uniform background,
checking the background colour,
checking for adequate background brightness,
checking for background shading,
checking the brightness of the face (which should not be too dark),
making sure there is no hat or veil,
making sure there are no accessories,
checking the proportions of the face,
making sure that the photo is taken full face and not of a profile.

Verifications can be automatic and/or manual.

Should rules not be observed:

preferably correction is automatic, and/or
correction is carried out manually by an operator, for example, for background clean up,
otherwise a message is sent back to the user, preferably rapidly; so that he/she may retake a photograph.

Such message indicates, for example, how to retake a photo without the defect.

Possible text input to be written on the back of the photo, for example:

the name
the name and class reference for a school photo.

Input of the recipient's postal address or of the photo pick-up point.

Possible choice of service provider.

Possible retouching of the image (background clean up, contrast, etc.). The retouching is done manually, via automatic photo transmission to an operator, and/or automatically.

Transmission.

This service can be adapted to country rules for official documents.

1.5. Other Possible Services with a Cameraphone (or Photophone):

Character recognition.

Face recognition.

Bar code reading.

Managing rights and digital signatures (“watermark”).

Personal Mobile Website (“blog”).

Text templates and photos, for example for Mother's Day or St. Valentine's Day or even for excerpts of poetry.

Medical SOS, for extreme situations, for example out at sea or up in the mountains.

Jointly agreed statement in the event of a car accident. An application asks questions and indicates the photos to be taken for drawing up a report.

Tele-diagnosis, for example for a sick plant.

Practical services

Measurements: for example, measuring a piece of furniture or other object on which an item having pre-defined dimensions, such as a credit card, is juxtaposed.

Colour: calculating a colour combination between two items. For example, matching colours between a pair of trousers and a pair of shoes, or between a tie and a shirt.

Miscellaneous services

Morpho astrology: every day a personalised horoscope, calculated using one's date of birth and face.

“Morpho matching”: evaluating the level of friendship between two persons, such level being based on photos of their faces.

Aura: adding a coloured “aura” to the person (or the item) on the photo.

Security and identification or authentication

Signature: the written signature (added to a number generated by a server, for example) can be used as authentication.

The photograph can also be used as authentication.

Services for professionals:

Estimate: the tradesman on call to prepare an estimate often needs to consult a specialist. The cameraphone provides a means for consulting with the fitter/supplier when drawing up the estimate. For example, a fitter of a motor for roller blinds can contact a roller blinds' fitter to determine the difficulties for dismantling.

It is also possible to receive approval from a customer for choices emerging at a late stage, for the purpose of avoiding delays or errors of appreciation, for example, for authorising a more severe tree-felling than originally planned, showing the roots preventing the digging of a trench with the cameraphone.

### 2. Improving the Quality of the Image and Page Layout

After taking a picture, several techniques can be used to improve the image quality and the user design:

Carrying out processes to improve the image.

Depending on the terminal's IT performance, its memory capacity, the size of the detector, the type of service and the ease of adding functions to the terminal, processes may be carried out on the terminal or on a server. In such a case, a data transmission format shall be defined.

Adapting processes to the defects of the detecting device. In such a case, shall be identified the origin of the images, namely by analysing the signature of the device.

Adapting processes to the defects of the restitution means. Hence it is necessary to identify the type of service and, possibly, the type of restitution means used and then to transmit such information.

In the case of a process on a server, the process consists of:

extracting the image from the message transmitted,

improving the image quality,

replacing the transmitted message image by the image so improved.

In order not to correct the images twice over, these can be marked, for example, by adding or modifying the Exif or similar metadata.

It should be noted here that by metadata is meant data linked to the multimedia data and corresponding to information relating to the format of the file containing the multimedia data, and/or to the information relating to the compression, and/or to the origin of the data, and/or to the acquisition specifications. For example, in the case of a photograph, the acquisition parameters (such as the focus, the aperture and the exposure time), and/or the results of calculation obtained using the multimedia data, such as the number of pixels.

Processing the image can be carried out in various ways:

a) No calculation is made locally (i.e. in the terminal) and the image is sent back to the user (i.e. terminal) after remote calculation (in a server).
b) Local calculation is made according to the terminal screen's resolution and a remote calculation is made for the image transmitted by the service.
c) Local calculation is made of the terminal screen's resolution and, for the image transmitted by the service, decompression is performed inside the server in addition to a clean-up of the compression artefacts prior to sending, the image processing transmitted for the service being able to be done locally and/or remotely.

In all events, the remote image transmission must be done by adapting the size and the compression to the service, as well as to the authorised message size, as described hereafter.

Similarly, the page layout can be performed locally or remotely:

a) No calculation is made locally, such calculation for the image transmitted by the service being done remotely and then returned to the user.
b) Local calculation is made according to the terminal screen's resolution and a remote calculation is made for the image transmitted by the service.
c) Local calculation is made of the terminal screen's resolution and, for the image transmitted by the service; decompression is performed inside the server in addition to a clean-up of the compression artefacts prior to sending.

Of course, the method described above can be applied to other types of multimedia data, namely relating to video, and/or audio, and/or text.

Thus can be obtained a method and a system to improve the quality of using a service, implementing at least a process, relating to at least one type of multimedia data, namely relating to photos, and/or video, and/or audio, and/or text, such service being proposed by a service provider and/or a telecommunications' operator inside a user's mobile telephone via a network.

Let us be reminded that this process is adapted to overcome the limitations resulting from at least one factor, affecting the quality of use, such as:

the size of the multimedia data, and/or

the IT resources of the mobile telephone, and/or

the quality of the multimedia data's acquisition device and/or restitution device

the transmission specifications of the said network,

the type of service.

Thus, the method includes the following steps:

shall be determined, a priori or in real time, according to the said factor, the fraction of the multimedia data and/or the fraction of the process having to be processed inside the mobile telephone and/or inside at least one remote server connectable to the mobile telephone,

shall be performed each fraction of the process thus determined and/or shall be processed each fraction of the multimedia data thus determined, either inside the mobile telephone, or inside the remote server, whichever the case;

so that, for the user, the quality of the service is increased, namely:

the service can be used with any type of multimedia data, for example photographs of an increasing size,

use of the service is improved for every terminal type,

the outcome of the service is improved in connection with the network's pass-band,

access to the service is simplified,

the time required to obtain the service is reduced,

the outcome of the service is improved (better photograph, video, audio perception),

access to new services is possible,

user satisfaction is increased.

For the service provider and/or the telecommunications' operator, new services can be provided.

This method can further include the following steps:

defining instructions relating to the remote process by means of a format,

for the mobile telephone, transmitting the instructions thus formatted to the remote server,

for the server, carrying out these instructions.

Such instructions may include:

the fraction of the multimedia data and/or an identifier enabling the server to obtain such fraction of the multimedia data,

the fraction of the process having to be performed on the server, hereafter referred to as the “remote process”, namely:

a process to improve the quality of the multimedia data, and/or

a retouching process of the multimedia data, and/or

an editing process of the multimedia data, and/or

a process to dispatch the service, and/or

a process to provide the service, and/or

the address of the beneficiary of the service and/or a code enabling the server to obtain the beneficiary's address.

The method further includes the step, for the server, to transmit the results of carrying out the instructions to the beneficiary of the service.

By “service” is particularly meant:

any service, namely the services described within this patent request,

a portion of a more comprehensive service, for example, remote calculation required by a service,

By “photo” is particularly meant:

a photo text and/or diagram and/or natural image.

By “process”, also called “correction”, is particularly meant:

all types of process described in this patent request,

a process to improve the quality,

a process to improve the quality, adapted to a telephone,

insertion into an album,

page layout,

sending.

By “IT resources” is particularly meant:

the IT performance,

the memory capacity,

the programming language.

By “transmission specifications” is particularly meant:

the pass-band,

the load,

the maximum size of the message.

By “identifier” is particularly meant:

an image code (transmitted to the server by SMS or other means), enabling a server to find the image chosen by the user.

By “code” is particularly meant:

a telephone number used to find out a postal address.

By “beneficiary” is particularly mean:

the user,

a third party.

By “instruction” is particularly meant, the data described in this patent request.

### 2.1. Types of Image Processing

The processes made to the images inside the terminal and/or on the server can be the following:

Removing or reducing all or part of the defects of the picture-taking device and/or from the picture taken: exposure, lighting, geometric distortion, chromatic aberration, vignetting, blurring, astigmatism, white balance, saturation, demosaicing, noise, movement blurring, focus blurring, compression artefact, unblurring artefact, artefact for other processes, aliasing artefact.

Removing all or part of the defects from the restitution means: terminal screen, computer screen, printing means.

Changing the size (number of pixels).

Compression.

Decompression with or without eliminating the artefacts.

Background clean-up in the case of a text and/or a drawing.

Retouching: converting to black and white, rotating, extracting from an image zone, applying effects, adding a frame.

Inlay on a background or another photograph.

Adding text.

Analysing the image quality in order to give advice to the user.

### 2.2. Instructions for Remote Process

It is possible to transfer a part of the processes depending on the terminal's capacity, on the memory capacity, on the image size, on the possibility to programme the terminal in C++ as opposed to Java programming, which is badly adapted for processing multimedia data, and on the type of service desired. For the user, processes remain in real time for operations requiring feedback to such user.

Information enabling to describe the transferred process (for each image, or once and for all) must be transmitted, namely:

a) The type of improvement process to be made on the server. This concerns, for example:

Correction of the terminal detecting defects of the data type for visualising on a computer screen.

Correction of the terminal detecting defects of the picture-taking type with automatic recognition for visualising on a computer screen.

Correction of the terminal detecting defects of the picture-taking type with automatic recognition for printer output.

Background clean-up for text photos and hand-drawn sketches.

Correction of the picture-taking terminal detecting defects with automatic recognition for visualising on a terminal screen of the data type.

Picture-taking quality analysis.

Even if no process is to be performed, such instruction must be transmitted, possibly by default.

b) Retouching to be made to the image (rotation, cropping, adding a frame, etc.), which enables retouching inside the terminal on an image reduced to the size of the screen and subsequent retouching when at the final size.
c) The types of services and their recipient(s):

MMS: numbers.

e-mail: addresses.

Postcard: service provider.

Facsimile: number.

Album: service provider.

Printing: service provider.

Feedback onto the issuing terminal.

d) Output editing indications:

Page layout (particularly colour and font) for postcards or other,

Inserting photos, text, or cleaned-up photographed text.

The editing data must be separate from the physical format in order to enable printing in several formats. The size and position of the text and image elements are determined downstream.

e) The contents:

address of the recipient (postal or other)

message

photo

text photo

Such contents can be transmitted as an address and/or metadata.

The contents can be described by a format. Such format can be open (standard and/or extensible); it can be an extension of the MMS “SMIL” format. It must be compatible with all types of dispatch protocol (MMS, http, WAP, e-mail, etc.) and thus compatible with the existing networks.

### 2.3. Transferred Processing of an Image

Preferably, in order to code the images for their transmission, a JPEG standard compression programme is used, which is implemented in all telephones; however, another format may be used. The image processing steps are as follows:

Possibly pre-processing.

Possibly optimisation of the image size, of the compression rate, of the image format (such format also includes colour choice and black & white) depending on the type of service and on the size of the transmission “pipe”:

by taking account of the optimal compression curve/image size according to the service and the pipe size, as described below, if the image is already compressed, the compression and size change are preferably carried out in the frequency domain in order to limit the calculation time,
otherwise compression takes place after changing the size.

Inside the server:

Everything is decompressed by eliminating the compression artefacts; then:

all or part of the picture-taking device's defects are removed or reduced, or, in the case of a text photo and/or a drawing (FotoText+), the background is cleaned up,
all or part of the defects of the restitution means are removed,
all other processes are applied: retouching, page layout, etc.,
the image is marked to prevent applying the process several times over.

The transfer is performed via MMS, surcharged MMS, e-mail, http, WAP or other means.

The message can be sent to a third party and/or used on the issuing terminal, for example to visualise the outcome or to receive advice.

### 2.4. Local Processing of a Service

Preferably, in order to code the images for their transmission, a JPEG standard compression programme installed in all terminals is used; however, another format can also be used. The image-processing steps are as follows:

a) Possibly pre-processing.

### b) Then:

removing or reducing all or part of the picture-taking device's defects or, in the case of a text photo and/or a drawing (FotoText+), performing a background clean-up,
removing all or part of the defects of the restitution means,
applying the other processes: retouching, page layout, for example.
c) Mark the image to avoid applying the same processes several times over;
possibly optimise the image size, the compression rate, and the image format depending on the type of service and the pipe size:
by taking account of the optimal compression curve/image size according to the service and the pipe size, if the image is already compressed, the compression and size change are preferably performed in the frequency domain in order to limit calculation time,
otherwise compression is carried out after changing the size.
d) For services using a large-size image:
inside the server, a decompression is carried out eliminating the compression artefacts, followed by, where necessary, an enlargement up to the size of use. Transfer can be performed directly towards the final user (except in the case of a postcard) or via a service provider.

### 2.5. System

The remote server, also called “correction server”, can be positioned:

inside the MMS-C (MMS processing system hosted by the operator),

at the entrance to the MMS-C,

at the exit of the MMS-C,

inside the WAP gateway,

inside the MM9

inside the MM7.

The following terminal and server combinations are possible:

standard terminal and server,

terminal with image-processing application, without a server,

terminal with image-processing application, with server,

terminal with application, though not processing, with server,

terminal with pre-processing application to give a preview to the user by way of a reduced-size image, with server.

The processes providing feedback to the user can be achieved:

locally (inside the terminal), or

remotely via http or another protocol.

### 2.6. Adapting the Image to the Size of the Pipe

The telecommunications' operators limit the size of messages transmitted, for example by MMS.

The size of an image file depends upon the contents of the image. For a given number of pixels and a given perceived level of quality, an image containing much detail will generate a file considerably larger than an image containing less detail.

It is thus necessary to automatically adapt the level of quality to enable the use of a service in all cases and not to exceed the pass-band allocated by the operator.

Several ways of adapting this level of quality exist, with the main point depending upon the use and thus the service type.

When using a service, the images adopt the following pattern:

a) Taking a picture and possible compression.
b) Pre-processing in order to optimise the size of the multimedia data, its compression rate applied and its format: adapting the pass-band allocated by the operator, by reducing the size of the file transmitted, such reduction being performed via a possible reduction in the number of pixels, and/or an increase in the rate of compression.
c) Decompression with, preferably, a reduction of artefacts.
d) Change in the number of pixels for the purpose of adapting to the screen or the printer used for the service (final number of pixels).

In order to reduce the file size, a compromise exists between the number of pixels and the compression used:

such compromise depends upon the final number of pixels and thus upon the type of service required and the decompression process, particularly whether the artefacts are to be reduced or not;

beyond a certain level of compression, it is advisable to reduce the number of pixels.

The file size reduction operations can take place:

preferably without decompressing the image within the frequency area, or

after image decompression, or

after image decompression and reduction of the artefacts.

### 2.7. Application Examples

Examples of process-distribution are set out below

a) Application with a 3G network

Such network enables fast terminal-server exchanges. It is thus possible to carry out processes inside the server and to rapidly display the outcome on the telephone.

Hence it is possible to work with any IT performance on the terminal and with a high number of pixels.

b) Application with a 2.5G and a top-of-the-range telephone (“Smartphone” in English).

The network does not enable fast terminal-server exchanges. However, the terminal has a high IT performance.

It is thus possible to carry out image processing inside the terminal according to the screen size in order to show a preview to the user and to rapidly display the outcome on the telephone.

It is thus possible to carry out full resolution processing on the server without requiring feedback towards the user.

c) Application with a 2.5G network and a middle-of-the-range telephone (“Featurephone” in English).

The network does not enable fast terminal-server exchanges.

The terminal has limited IT performance and exchanges are slow. The availability of previews for the user shall be more limited, although the other advantages (design, accessibility to services, etc.) are maintained.

It is thus possible to carry out processes inside the server by limiting feedback towards the user.

### 3. Photography-Text Solution (Fototext+Component)−Background Clean-Up

The invention allows for a component, called “FotoText+”, which is a text scanner enabling to transform a photo taken of any document “of the binary type”, for example comprised of strokes on a clear background, particularly a handwritten text, an outline drawing, map or sketch, a printed text.

This component corrects the paper defects (background clean-up): the paper's shading, squares or lines, folds, stains, crumpling, and, of course, the camera and lighting defects. This can be done by extracting information above a threshold.

It optimises the contrast level.

It performs an automatic correction of the focussing “close-up blurring”, for example by applying an unblurring mask. Indeed, cameraphones are programmed for 80 cm sharpness to infinity and, in general, do not have auto-focus. However, the photo of a text is taken at a distance of approximately 15 cm, i.e. within the blur range of the cameraphone.

If this defect is hardly sensitive to very low resolutions (such as that on a screen: 160×120, or CIF), it is particularly sensitive as of 300,000 pixels (VGA).

It also corrects the colorimetric defects.

It is compatible with very high compression. Thus, a text photo representing approximately 25 ko, only represents a maximum of 5 ko after compression—in order to optimise transfer.

After decompression, then processing, the image is put back into printing format for an improved superimposition on a background: enlargement up to 300 points per inch or according to the format of the final document.

The component produces level grey strokes on a uniform background.

It can be used in various manners:

alone:
to display, after picture-taking, on a terminal screen, seeing as the processed image is more readable than the original image,
to send to another recipient (by MMS or other),
on the reverse side of a postcard (message and/or address);
illustrating an image:
using a touch-up software, which enables to superimpose the cleaned-up image on a photo by making the background colour transparent through a mixing operation between the photo and a uniform colour or a texture while using the cleaned-up image as a mask. For each pixel, if the grey level of the cleaned-up image has an IN value, the photo has a PH value and the uniform colour or texture has a CO value, we take CO*(1−IN)/MAXIN+PH*IN/MAXIN where MAXIN is the maximum value of all the pixels in the cleaned-up image.

For example, for a postcard, the user takes two photos:

a) the photo for the front side of the postcard, and
b) the photo of a written/drawn text/graphic on a piece of paper.

A user interface enables to position the text/graphic onto the front-side of the photo; a local or remote terminal screen resolution process enables to display a preview, thus facilitating the work of the user.

The photo of the text/graphic is processed, cleaned by eliminating the non-uniform lighting zones to enhance readability, cleaned on its background and printed on the front-side of the photo.

In the case of a photo, particularly a passport photo, the background cleaning consists of making uniform all parts of the photo other than the actual person photographed, for example by detecting the outline of the face and filling the surrounds with a uniform colour.

### 4. Examples of Services

Described below, using FIGS. 1b to 8, is a postcard-making service, also called “photocard”.

The figures illustrate the various screens of the terminal interface, which represents the service to the user and the user guide.

The figures also represent the automatic implementation of several terminal functions necessary to the service, such automatic implementation of the terminal's functions including the following steps:

selecting, from among the functions available inside the terminal, the functions necessary to the service,

preparing, automatically and/or manually, by the user of at least one scenario adapted to the service, such scenario being composed of logical chain sequences for the functions selected,

the method further including the step, for the user, to choose a scenario determined among the scenarios previously prepared.

Screen 10 illustrated in FIG. 1b corresponds to the welcome after selecting the postcard service, which has been guided by using a terminal interface which represents the services accessible to the user via the terminal. It concerns a welcome screen which offers, when activated, the choice between several scenarios adapted to the service, also called “action”, which are, as represented: “new photocards”, “draft”, “cards sent”, “card sending in progress”, “templates”. The choice is made using the terminal's “joystick” by selecting one of the actions. Each scenario is composed of logic chain sequences of the picture-taking functions, searching inside an album, keying in text, searching for an address, a page layout. A mechanism for preferences and templates enables to pre-record at least one portion of the scenario.

It is also possible to activate the “options” menu which then displays a screen 12 enabling the user to select the action, the preferences, assistance, or even to quit the service.

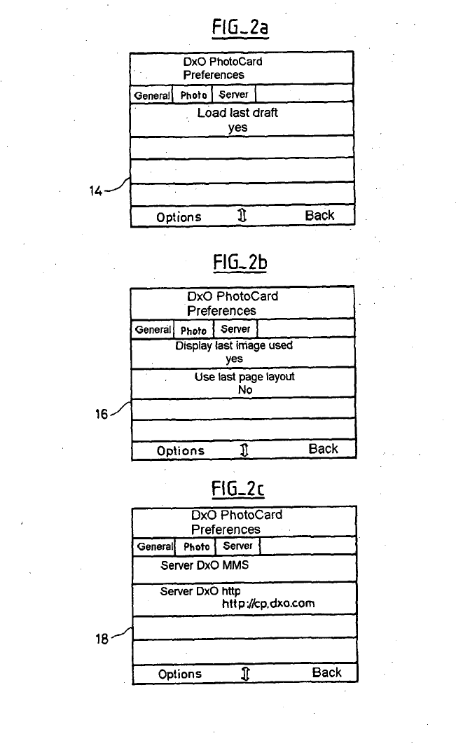

When selecting preferences, shown in the example in FIGS. 2a, 2b and 2c, the user can choose among three preferences, namely “general” (FIG. 2a), “photo” (FIG. 2b) and “server” (FIG. 2c), by using the left or right joystick.

On the screen 14 in FIG. 2a, corresponding to the “general” tab, the user is asked if he/she wants to automatically load his/her last draft.

On the screen 16 (FIG. 2b) corresponding to the “photo” tab of the preference section, the user is asked if he/she wants to automatically display the last image used and if he/she wants to automatically use the last page layout.

On the screen 18 of FIG. 2c, corresponding to the “server” tab of the preferences menu, the user is asked to which server he/she wants to connect, such as an MMS or http server.

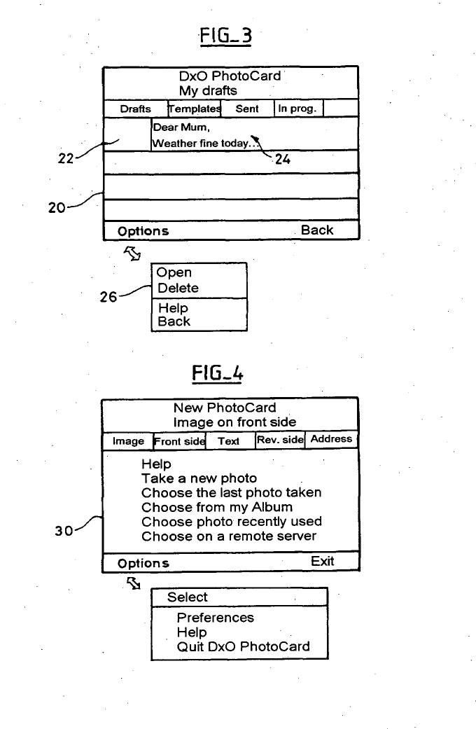

On FIG. 3 is shown screen 20, as displayed when the user selects an action with the “Select” option menu of the screen 12 of FIG. 1b. Thus, screen 20 is shown on which are displayed the available options between draft, template, card to be sent and card sending in progress. On screen 20, the latest draft is shown which comprises a photo 22 and a text 24. The menu option of screen 20 enables to access a screen 26 with the “open” command.

When choosing such “open” command, or when selecting the creation and sending of a new postcard on FIG. 1b, it is possible to select an image for the “front side” (page layout), text for the “reverse side” (page layout) and the address, as shown in FIG. 4.

The screen 30 illustrated in FIG. 4 corresponds to the selection of an image which, as shown, indicates that it concerns the service for creating a new postcard with the image on the front side, providing the possibility to take a new photograph, to choose the last photo taken, to choose the photo from an album stored in the terminal's memory, to choose a photo recently used for the same service, or finally to choose a photo from a remote server. In such a case, a user's personal album of multimedia data can be managed, such album being stored on a server accessible to the user's mobile telephone terminal via the telecommunications' network.

To take a new photo, preferably automatic assistance is provided to the user in order to acquire the image by helping with the framing. Such assistance with the framing consists of superimposing a silhouette on the image which indicates to the user how to frame in different cases, which can be chosen on a horizontal screen (an image that is more wide than high) or on a vertical screen, which enables to obtain both a correctly framed image and a better resolution than if a previous reframing was performed. Such assistance with the framing preferably respects the “golden rule” of photography said about the three thirds: never centre the subject or the horizon. The user can choose, by activating the joystick, between several cases of use, corresponding, for example, to the following situations: close-up, bust, group, scene, text photo using a horizontal or vertical screen.

When choosing the “front side” tab (FIG. 5), assistance for the front-side page layout is provided. If the user chooses in advance a preferred page layout, then such layout is directly displayed. If not, the screen, as shown, displays a list of options, i.e. enabling to choose a page layout inside the terminal or to choose from the remote server, or to create a new page layout.

When selecting “Choose a page layout”, a choice is then provided between several types of page layouts, such page layouts differing in colour, in style, in size, etc.

If the user chooses the option “Create a new page layout”, a series of options are proposed which, in the example, are: the choice of the frame colour, the thickness of the frame, and the choice of a card with rounded corners with a choice of curvature radii.

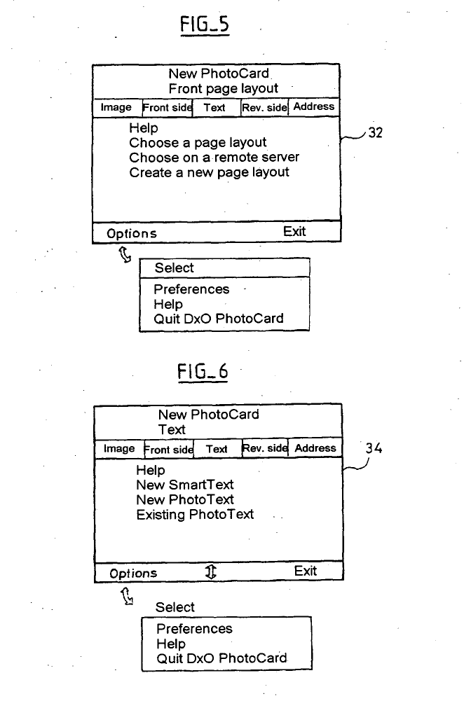

When the user clicks on the “text” tab of the screen 30 shown in FIG. 4, screen 34 from FIG. 6 then appears providing a choice between a new text of the “smart text” type (text with semi-automatic input), a new “photo-text” or an existing photo-text.

When choosing the “new text” option, the man/machine interface switches to text creation with standard input or semi-automatic input, which consists of allowing several fields for the text and reusing, in each one of the fields, texts already memorised. The first field is the header field which refers to the recipient: “Dear friend”, “Dear Mum”, etc. A second field concerns the body of the text: “It's fine today”, “Great holidays!”, etc. A third field concerns the closing of the text including the formal ending and a fourth field includes the signature.

When selecting the “photo-text” option, a screen (not illustrated) is then displayed to inform the user that he/she has to take a photo of a text, for example handwritten, with instructions for correctly taking a text photo, such as “make sure you are quite parallel” and “try to have uniform lighting”.

In an embodiment, a rectangular framing is displayed on the screen and enables to determine, depending on if it is deformed or not, whether the photograph is taken with the correct angle.

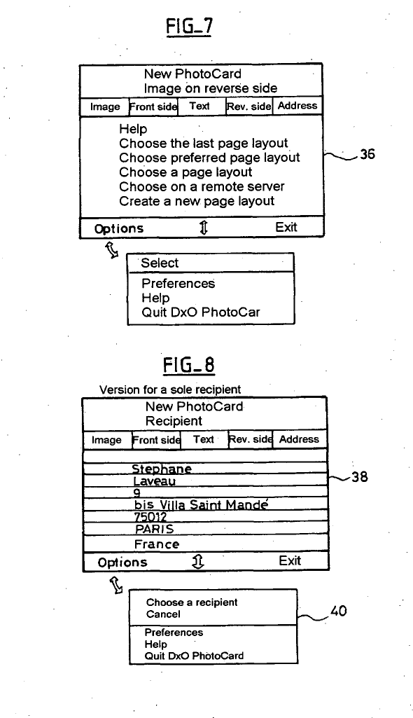

Once the text has been composed or photographed, the user can move on to the next step corresponding to the “reverse side” tab of FIG. 4, and which refers to the page layout of the reverse side, i.e. for the text. In such a case, the screen 36 in FIG. 7 is displayed and provides the following options:

choosing the last page layout,

choosing the preferred page layout,

choosing a page layout,

choosing a page layout on a remote server, and creating a new page layout.

The choice of the page layout, which can be found, for example, in the terminal's memory, consists, in an embodiment, of choosing the type of postage stamp to be used and corresponding, for example, to the place where the photo was taken. It can also consist of choosing the background colour.

For creating a new page layout, a choice of fonts, a size of font, an overall colour and stamp are all proposed.

FIG. 8 shows the screen 38 which appears when the user chooses the “address” tab on the screen in FIG. 4. If the terminal already contains an address book or a list of contacts, then the recipient is chosen from the contacts' list using the “option” box (screen 40). If it concerns a new contact, then the screen will show several zones for the first name (which can then be chosen by making contact with option T9), the family name, the street number, the street name, the post code of the town and the country.

Preferably, when the post code is indicated, the corresponding town automatically appears, and reciprocally, when the town is indicated, the post code is automatically shown.

It is also possible to choose several recipients for a same postcard.

If the postcard is incomplete, a screen will mention that such postcard is not complete and will ask to choose an image, a recipient and a text; it will also indicate that a default front-side page layout (image) has been used and that, similarly, a default reverse-side page layout (text) has been used.

If the postcard is complete, then the sending screen indicates that the postcard is ready to be sent and proposes the user to save it as a template.

Finally, after the user selects the “send” option, the photo is compressed according to at least one specification of the network relating to its transmission output (for example, the maximum size of MMS messages) by optimising the quality of the image transmitted by way of the protocol described below enabling to choose, for the purpose of such optimisation, the sub-sampling rate and the compression parameters, namely of the JPEG type. Then the photo, thus compressed, and the postcard are sent via telephony, for example by MMS. A screen shows that the postcard has been sent and proposes the user to send the same card to another recipient.

### 5. Adapting the Data to be Transmitted to the Network Transmission Capacity

The capacity of the detectors in cameraphones is constantly increasing and widely exceeds the pass-band containing the transmission protocols. For example, a VGA detector provides 300,000 pixels and each pixel uses one octet in order to code each one of the colour channels, which provides a gross image of approximately 900 ko. However, most terminals are only capable of sending files, once compressed, of 30 to 50 ko, i.e. approximately 3 to 5% of the initial data in the case of a VGA detector.

Based on such observation, the invention proposes a method which enables to optimise the image quality transmitted due to a protocol which enables to choose, in light of such optimisation, the rate of the sub-sampling, and the compression parameters, namely of the JPEG type.

It is in fact known that, in order to reduce the image file size, sub-sampling can be done on the one hand, while it can be compressed on the other using a compression algorithm, such as the JPEG algorithm.

Subsequent sub-sampling and re-sampling reduce the resolution and entail a loss of detail as well as aliasing.

Furthermore, the JPEG compression leads to a loss of information and causes the appearance of artefacts (defects), which are all the more important as the compression rate is high.

Having said that, the loss of resolution caused by re-sampling may no longer be corrected. On the other hand, the artefacts caused by JPEG compression have an organised and known distribution which enables them to be corrected within a certain limit. Such correction is performed, for example, by smoothing the unit edges as described in the JPEG standard or even by an algorithm known as the “JPEG CLEANER” enabling to decompress and correct such defects.

In order to determine the compression rate and the sampling rate, the chart shown in FIG. 9 is used where is indicated the compression rate in abscissae and the sampling rate in ordinates.

Such chart comprises three curves corresponding to three different images.

The chart is obtained in the following manner: three test images are selected which represent at the outset a 1 mega pixel definition.

Using such images, copies compressed at different rates are generated, thus enabling to obtain files of a given size: 200 ko, 150 ko, 100 ko, 80 ko, 60 ko, 55 ko, 50 ko, 45 ko, 40 ko, 35 ko, etc., re-sampled in advance, the sampling rate being by 90%, 80%, 70%, 60%, etc., the sampling rate being the same whether being in horizontal or vertical direction.

The images are then categorised by file size and each group of files is thus comprised of images having the same size, though with varying definitions.

In order to be able to compare the different images thus obtained, such images were put back into the definition of the original by way of an interpolation calculation of the bi-cubic type.

Next, for each series of images, an experienced viewer observed the various images on a computer screen and determined the image that he/she judged the most satisfactory compared with a file of similar size, while noting of course, the sub-sampling rate and the corresponding compression factor.

It was noted that the association of the JPEG compression to image re-sampling enables to obtain better results than either of the methods used separately.

Hence it was noted that the chart in FIG. 9 enables to choose, for a given compression rate, the value of the sampling rate providing the best image quality.

In the chart shown in FIG. 10, the ko image file size is stated in abscissae, while the sampling rate is stated in ordinates. The curves illustrated in this FIG. 10 show the most satisfactory image according to the file size and the sampling rate.

Based on a 1 mega pixel image which represents approx 3 Mo in size without compression, for the purpose of obtaining a 30 ko file, it is preferable to sub-sample the image by 50% (which corresponds to a 4-factor reduction in the number of pixels) prior to image compressing. To obtain a 50 ko file, it is advisable to sub-sample the image by 70% (i.e. a 2-factor reduction in the number of pixels) prior to image compressing. Finally, for a file exceeding 130 ko, it is preferable to use only a JPEG compression, without sub-sampling.

In practice, the mobile telephone terminal contains in the memory the charts shown in FIGS. 9a and 10a, also known, within the meaning of the invention, as the optimal compression curve according to the size of the multimedia data. FIG. 9a represents a chart with a 50 curve constituting an average of all the curves in FIG. 9, while the chart in FIG. 10a contains a 52 curve corresponding to an average value of the curves in FIG. 10.

Thus, in order to determine the file that should be sent over the network, an algorithm linked to the file size is programmed inside the mobile telephone terminal, which can be transmitted by the latter over the network. This file size in abscissae in FIG. 10a corresponds to a sampling rate in ordinates in the same figure. Such sampling rate enables to determine, using the 50 curve from FIG. 9a, a compression rate in abscissae from FIG. 9a. This algorithm is represented by the arrows leaving from point A in abscissae in FIG. 10a to reach point B in abscissae in FIG. 9a.

However, the compression rate obtained can provide a file size exceeding that supported by the network, as, for a given compression rate, the final file size shall depend upon the amount of details contained in the image. This is why, in such a case, the algorithm selects a higher compression rate B′, which enables to select a corresponding sampling rate due to the 50 curve of FIG. 9a and to verify, using the chart in FIG. 10a, whether the file size A′ is lower than the maximum allowed by the network. Such repetitive procedure continues if size A′ is still too large, i.e. by selecting a file size A″, lower than A′, until achieving a satisfactory file size.

Of course, the optimal compression curve depending on the multimedia data size can be represented inside the terminal's memory in the form of charts from FIGS. 9a and 10a, but also as value tables or algorithms.

And of course, only the necessary part of the optimal compression curve could be represented inside the terminal's memory depending on the size of the multimedia data. The necessary part being, for example, the extract corresponding to the maximum file sizes able to transit by the networks of the various telephone operators.

### Methods of Using the Images

Now we are going to describe a method of embodiment which can apply as much to the mobile telephone service to an image acquisition device, such as a photographic device or a video camera.

Before proceeding with this description, let us first indicate the meaning of the various terms used:

By “digital image” is meant an image in digital form. The image can stem from a digital image-acquiring device, also called “image-detecting device”. The image can a fixed or moving image destined to be transmitted or saved.

The digital image can be represented by a group of digital values, hereafter called the “grey level”, each digital value having linked colour sensitivity and a relative geometric position on a surface or for a volume. “Colour” within the meaning of the invention refers to the group of digital values linked to the same colour sensitivity.

The digital image is preferably the detector's raw image prior to dematrixing (or “demosaicing” in English). The digital image can also have undergone a process, for example, demosaicing, white balance or sub-sampling.

When the digital image stems from an image-detecting device, the latter includes a detector equipped with sensitive components. By “sensitive component” is meant a detector component enabling to convert a flow of energy into an electrical signal. The energy flow can take the form of a light flow, X rays, a magnetic field, an electromagnetic field or sound waves. The sensitive components can be, depending on the case, juxtaposed on a surface and/or superimposed inside a volume. The sensitive components can be placed according to a rectangular matrix, a hexagonal matrix or other geometry.

The invention is applied to detectors comprising sensitive components of one or several different type(s), each type being sensitive to colour, each colour sensitivity corresponding to a part of the energy flow converted into an electric signal by the detector's sensitive component. In the case of a visible image detector, the detectors are generally sensitive to 3 colours and the digital image to 3 colours: red, green and blue. Some detectors have a 4-colour sensitivity: red, green, emerald, bleu.

By “colour” is generally meant a combination, particularly linear, of signals delivered by the detector.

The invention is applied with the various known sharpness definitions. For example, the sharpness of a colour can correspond to the measurement of a value referred to as “BXU”, which is a measurement of the blur spot surface, such as described in the article published in the “Proceeding of IEEE, International Conference of Image Processing, Singapore 2004”, and entitled “Uniqueness of Blur Measure”, by Jérôme BUZZI and Frédéric GUICHARD.

Simply-speaking, the blur of an optical system is measured based on the image, called “impulsional response”, from an infinitely tiny point located in the scope of sharpness. The BXU parameter is the variant of the impulsional response (i.e. it average surface area). The processing performances can be limited to a BXU maximum value.

Various measuring methods of such a sharpness are described in the handbooks and publications, such as, for example, the “Handbook of Image & Video Processing” edited by Al Bovik and published by Academic Press, pages 415 to 430.

In an embodiment, sharpness is achieved by calculating a gradient. For example, sharpness can be achieved by a gradient calculation of 9 grey levels taken from neighbouring geometric positions.

In an implementation:

An image-detecting device is, for example, a disposable camera, a digital camera, a reflex camera (digital or not), a scanner, a facsimile, an endoscope, a cine-camera, a camcorder, a surveillance camera, a toy, a cine-camera or camera integrated or linked up to a telephone, to a personal assistance or to a computer, a thermal camera, an ultrasound, magnetic resonance imaging, X-ray device.

By “optical image-detecting system” is meant the optical means enabling to reproduce the images on a detector.

By “image detector” is meant the mechanical, chemical or electronic means enabling to detect and/or to record an image.

By “servo-control system” or “servo-control” is meant mechanical, chemical, electronic or IT means which impose instructions on the components or the device's parameters. It particularly refers to an automatic focussing system (autofocus), to automatic white balance control, to automatic exposure control, to optical components' control in order, for example, to maintain a uniform image quality, to an image-stabilising system, to an optical and/or digital zoom-factor control, or to a saturation control system, or to a contrast control system.

The means for digitally-processing images can be varied depending on the application.

The means for digitally-processing images can be integrated, in all or in part, as in the following examples:

An image-detecting device which produces modified images, for example a digital camera in which are integrated image-processing means.

An image-restitution device which displays or prints modified images, for example a video projector or a printer including image-processing means.

A multi-function device which corrects the defects of its components, for example scanner/printer/facsimile including image-processing means.

A professional image-detecting device which produces modified images, for example an endoscope including image-processing means.

The image-processing means can be transferred in all or in part onto a server.

### Adjusting the Device, Picture-Taking Parameter:

By “device adjustment” or “picture-taking device” is meant an explicit adjustment, such as, in the case of a photophone, adjustment when sending an image towards another mobile telephone or towards a printing service, or an implicit adjustment, such as, still in the case of a photophone, a recipient's telephone number input by the user for sending a message, or even automatic, for example, adjusting automatic exposure according to the lighting.

The adjustment of the picture-taking device or parameters comprises, namely, one or several of the following elements:

The modes of use, for example: automatic, aperture priority, speed priority, portrait, scene, sport, darkness. The use particularly has an influence on the ISO sensitivity, the exposure time, the noise, the blur.

Manual exposure correction, which particularly has an influence on the noise and on contrast.

The ISO sensitivity adjustment, which particularly has an influence on the noise and on the movement blur.

The exposure-time adjustment, which particularly has an influence on the movement blur.

The aperture adjustment, which particularly has an influence on the blur.

The focussing adjustment, which particularly has an influence on the blur.

The macro mode, which particularly has an influence on the blur.

The white balance adjustment, for example: automatic, tungsten, fluorescent, halogen, sunny, cloudy, shady, which particularly has an influence on the colour.

The contrast adjustment, for example: strong, normal, weak, which particularly has an influence on the contrast.

The sharpness adjustment, for example: strong, normal, weak, which particularly has an influence on the blur.

The resolution adjustment, which particularly has an influence on detail and on sharpness.

The digital zoom adjustment, which particularly has an influence on detail.

The colour-rendering adjustment, for example: colour, black and white, sepia, saturated, which particularly has an influence on the colour.

The output calorimetric area, which particularly has an influence on the colour.

The maximum value of the digital zoom factor. In order to deactivate the zoom, it will be given the value of 1.

The parameters of the various servo-controls.

The image-processing parameters, namely:

the coefficients and tables used by the various filters and processing necessary to create colour, sharpness, contrast, details and noise reduction,
the demosaicing parameters, for “tone curve” (which is a status map used to adapt the dynamism of the detector's signal, for example 8 bits), for noise reduction, for white balance, for interpolation.

The other parameters, fixed or variable according to the image and having an influence on the image or on the image delivered by the service.

An indication of the image's end use in the form of one or several services and/or in the form of the number of pixels necessary for the use and/or in the form of a type of restitution device (namely the device's screen, printing, enlargement, etc.) and/or in one of the forms described below.

The image's end use can be indicated in several ways: when creating a message for a particular service, for example:

for a postcard service on a mobile telephone after requesting creation of a postcard,

for an MMS service on a mobile telephone after choosing the recipient, which enables, if it concerns a postcard service number or address, to know that the image is going to be printed, if it concerns an e-mail address, to know that the image is going to be used on a computer screen or for printing, and if it concerns a telephone number, to know that the image is going to be used on a mobile telephone screen, via an adjustment performed by the user, via an adjustment performed by the service operator, via an adjustment performed by the telephone manufacturer or the seller, in order to favour certain types of services,

via a history of image usages.

### Using the Image:

In the case where the multimedia data is an image, by “service” is particularly meant services, such as described above, but also services corresponding to a determined image use, the service not necessarily being proposed by a service provider, but also being able to be performed by the user him/herself or by a third party; using the determined image can especially correspond to image-sharing (on a small-size screen, on a computer screen, for printing, on electronic or physical media) and memory (filing for later consultation by printing or saving the image file) usages, such as:

displaying on a small-size screen, usually by at least 100,000 pixels, namely: the acquisition device's screen, the screen of another device or the screen of a multimedia data storage device,

the display on a large-size screen, usually by 1 to 2 million pixels, particularly a computer, a television or a projector screen,

printing in standard format (10 cm×15 cm approx.), usually by 2 million pixels,

enlargement by several million pixels,

retouching,

filing on electronic media (hard disk, CD, DVD, etc.).

It is possible to group the services together according to the number of pixels necessary for use:

using in small size, for example 100,000 pixels,

using in standard size, for example by 1 to 2 million pixels,

using in the maximum possible size.

In an embodiment, the quality of using the service is increased by using image-using information. Such information can be:

directly indicated by the user:

by indicating a service to be used,
by indicating a maximum image size to be used,

calculated

using an image quality adjustment,
by using other adjustments.

### PRIOR ART

Now we are going to describe how works a device, such as currently embodied without availability of the invention which shall be described below.

The device generally is equipped with an image-adjustment resolution.

The image acquisition includes all or part of the following steps:

exposure servo-control prior to taking a picture,

focussing servo-control prior to taking a picture,

white-balance servo-control prior to taking a picture,

displaying a reduced-size video prior to taking a picture,

acquiring a “raw” image using all or part of the detector, according to the digital zoom (only the centre is used) and possible the resolution,

image demosaicing by interpolation of the missing colours in each pixel,

application of a contrast curve (“tone curve” in English),

white-balance correction,

noise reduction,

increase in the sharpness,

passing into the output colour area,

interpolation in order to achieve the requested resolution using the pixels available,

compression,

image markup for sending by e-mail, printing.

### EXAMPLE OF AN EMBODIMENT

Now we are going to describe an invention embodiment in which the multimedia data is an image, the characteristics of such image being the picture-taking parameters which are automatically determined according to the service, so that, particularly, an image destined to a mobile telephone can benefit from a longer exposure time than an image destined to a printing service or to be displayed on a computer screen.

Thus such embodiment is more particularly adapted to the case where:

the multimedia data is an image,

improving the quality of use corresponds to an improvement of the image quality,

the device can be a terminal, but also a camera or any other device linked to the image, such as described above,

the use of the image is known having been determined or calculated as previously described, particularly based on a service.

In such embodiment, the method includes the step for automatically determining the specifications of the multimedia data according to the service selected, the characteristics of such image being the picture-taking parameters.

In such example, the picture-taking parameters are determined in order to optimise the image to be used as:

a small-size image, and/or

a standard-size image, and/or

a maximum-size image.

The method includes at least one of the following steps:

adapting the digital zoom according to use,

adapting the exposure servo-control according to use,

adapting the number of pixels acquired according to use,

adapting the demosaicing according to use,

adapting the increase in sharpness according to use,

adapting noise reduction according to use.

The following example corresponds to a 4 million pixel detector.

A digital zoom consists of not only using the central zone of the detector. Thus, for a x2 digital zoom, only the central quarter of detector's pixels shall be maintained.

In order to adapt the digital zoom to the use, a maximum zoom factor can be calculated so that the number of pixels acquired is close to the number of pixels for using the image. For example:

for a small-size use, the digital zoom is limited to the square root of (4,000,000/100,000), i.e. approx. 6,

for a standard-size use, the digital zoom is limited to the square root of (4,000,000/1,000,000), i.e. approx. 2,

for a maximum-size use, the digital zoom is not permitted.

The exposure servo-control measures the quantity of lighting on the detector and adjusts the exposure time, the aperture and the detector gain (linked to the ISO sensitivity) according to the adjustments of the device in order to achieve a target exposure.

In order to adapt the exposure servo-control according to use, it is possible to:

increase the exposure time for the smallest sizes of use, seeing as the movement blur is less visible on a small image; thus a lower noise can be achieved,

take account of the reduction in the number of pixels acquired and the noise reduction in order to fix a higher gain.

In order to adapt the number of pixels acquired according to the use:

It is possible, for small and/or standard sizes of use, to acquire 4 times the number of pixels for use (for example, for use in small size with 100,000 pixels, an image of 400,000 pixels is obtained), which enables to simplify the calculations per pixel: the demosaicing can be simplified by the known method of superimposing 4 neighbouring pixels instead of using an interpolation in order to recreate the missing colours in each pixel. Thus shall be obtained a smaller image, which enables the colour, the contrast, the sharpness and the detail to be re-established as fast as possible (such calculations being proportional to the number of pixels), easier calculations of the sharpness per pixel, seeing as it is possible to reduce the size of the sharpness filter, such filter being less complex the more the resolution is low, which enables in the end to have a higher IT performance in order to reduce noise.

It is also possible, when the amount of lighting is low, to acquire a raw image, to perform fast demosaicing in order to achieve an image 4 times smaller, to continue processing the conversion of a visible image on this reduced image, and to use the IT performance thus freed in order to carry out a noise-reduction process much less complex.

For example:

if the conversion process of the detector's raw image into a visible image corresponds to 150 operations per visible pixel, 25 of which for reducing noise;

if the conversion process of the detector's raw image into a visible image with simplified demosaicing corresponds to 100 operations per visible pixel, 25 of which for reducing noise;

then can be added 500 operations per visible pixel for reducing noise, which enables to use a calculation 20 times more complex than the 25 noise-reduction operations. In fact, 100+500 operations per pixel out of a number of pixels 4 times less corresponds to the same IT performance as 125+25 on all the pixels. Thus, the picture-taking parameters have been automatically determined according to the service and the amount of lighting when taking a picture, since instead of providing an image that cannot be used for the service, an image with 4 times less detail is supplied, though with a noise level considerably reduced, for example from 6 to 9 dB, this makes the image unusable.

In order to adapt demosaicing according to use:

4 times the number of pixels to be used can be acquired and demosaicing can be simplified through the known method of superimposing 4 neighbouring pixels.

In order to adapt noise reduction according to the use, it is possible, as described above, to free the IT performance, which enables to reduce the noise by using a wider span of pixels, for example by using an algorithm such as described in the article by Carlo Tomasi and Roberto Manduchi, “Bilateral Filtering for Gray and Color Images”, pages 839-846, in the proceedings from the International Conference in Computer Vision, 1998.

In contrast to the existing devices, which produce an image of the requested size, the invention enables to obtain a maximum quality image, particularly in low lighting, compatible with the use by adapting the acquisition, the size and the processes.

Such embodiment method of the invention can also be used:

for the acquisition of two images from the same scene in low lighting, with adjustments for the image size in “small” and “large” or an equivalent in terms of the service selected.

With the invention, there exists a span for the amount of lighting for which the small image is of better quality than the large reduced image.

When the exposure time and the gain (ISO sensitivity) are available inside the data in Exif format for the images, the parameters shall be considerably different between the 2 images.

### Use in Small Size

Now we are going to describe an embodiment of the invention more particularly adapted to an image use in small size. In order to illustrate such embodiment, a 4,000,000 pixels' detector shall be considered, the invention, however, being applicable to all detector sizes.

One or several picture-taking parameters can be determined, namely:

the maximum value of a digital zoom: for use in small size, the digital zoom is limited to the square root of (4,000,000/100,000), i.e. approx. 6,

the exposure time can be fixed at 1/15 for varying sensitivities from 100 to 3200 ISO, then increasing above 3200 ISO,

the sensitivity can vary between 100 and 3200 ISO,

the size of the raw image fixed at 4 times the number of pixels for use, 400,000 pixels in the example,

the demosaicing method: demosaicing can be simplified by the known method of superimposing 4 neighbouring pixels,

the noise reduction parameters: a wider span is used, for example 256 pixels,

the sharpness parameters: a smaller filter shall be used, for example 3×3.

### Use in Standard Size

Now we are going to describe an embodiment for the invention more specifically adapted to an image use in standard size. In order to illustrate such embodiment, a 4,000,000 pixels' detector shall be considered, the invention, however, being applicable to all detector sizes.

One or several picture-taking parameters can be determined, namely:

the exposure time can be fixed at 1/60 for varying sensitivities from 100 to 800 ISO, then increasing above 800 ISO,

the sensitivity can vary between 100 and 800 ISO,

the size of the raw image fixed at 4 times the number of pixels for use, 400,000 pixels in the example,

the demosaicing method: demosaicing can be simplified by the known method of superimposing 4 neighbouring pixels,

the noise reduction parameters: an average span is used, for example 64 pixels,

the sharpness parameters: a larger filter shall be used, for example 5×5.

### Use in Maximum Size

Now we are going to describe an embodiment for the invention more specifically adapted to an image use in maximum size. In order to illustrate such embodiment, a 4,000,000 pixels' detector shall be considered, the invention, however, being applicable to all detector sizes.

One or several picture-taking parameters can be determined, namely:

the exposure time can be fixed at 1/60 for varying sensitivities from 100 to 400 ISO, then increasing above 400 ISO,

the sensitivity can vary between 100 and 400 ISO,

the size of the raw image fixed at 4 times the number of pixels for use, 400,000 pixels in the example,

the demosaicing method: interpolation is used to calculate the missing colours in each pixel,

the noise reduction parameters: a smaller span is used, for example 16 pixels,

the sharpness parameters: a larger filter shall be used, for example 5×5.

### Use in Maximum Size Taking Account of the Lighting

Now we are going to describe a variant embodiment for the invention in which the multimedia data is an image, the multimedia data being acquired in order to provide at least two services, the characteristics of such image being the picture-taking parameters which are automatically determined according to at least one of the two services and to the amount of lighting when taking a picture, so that, particularly, in low lighting, the image can be used for at least one of the two services. Such embodiment is more particularly adapted to an image use in maximum size and by taking account of the lighting. In order to illustrate such embodiment, a 4,000,000 pixels' detector shall be considered, the invention, however, being applicable to all detector sizes.

In this case:

If there is enough lighting, it is possible to obtain a good quality image in full resolution.

Below a certain threshold of lighting, it is not possible to achieve a good quality image in full resolution. It is thus preferable to reduce the image resolution, which enables to optimise the image quality in standard size. It is then possible to enlarge the image thus obtained in order to achieve a full-resolution image with good colours, a good contrast, good sharpness and with low noise, even if the detail is not very fine.

Below a second threshold of lighting, lower than the first, it is not possible to achieve a good quality image in standard size. It is thus preferable to reduce the image resolution, which enables to optimise the image quality in small size. It is then possible to enlarge the image thus obtained in order to achieve a standard-resolution image with good colours, a good contrast, good sharpness and with low noise, even if the detail is not very fine.

Thus, the picture-taking parameters shall have been automatically determined according to at least two types of image use and the amount of lighting when taking a picture in order to improve the image quality for at least one use.

The quantity of lighting is determined by the exposure servo-control according to a known method.

One or several picture-taking parameters can be determined, namely:

Above the first threshold of lighting, an image of 4,000,000 pixels is expected:

the exposure time can be fixed at 1/60 for varying sensitivities from 100 to 400 ISO, then increasing above 400 ISO,
the sensitivity can vary between 100 and 400 ISO,
the size of the raw image is fixed at 4,000,000 pixels in the example,
the demosaicing method uses interpolation to calculate the missing colours in each pixel, and thus to obtain a visible image of 4,000,000 pixels,
the noise reduction parameters: a smaller span is used, for example 4 pixels,
the sharpness parameters: a larger filter shall be used, for example 5×5.

Between the first and second threshold of lighting, an image of 1,000,000 pixels is expected:

the exposure time can be fixed at 1/60 for varying sensitivities from 100 to 800 ISO, then increasing above 400 ISO,
the sensitivity can vary between 100 and 800 ISO,
the size of the raw image is fixed at 4 times the number of pixels for use, 4,000,000 pixels in the example,
the demosaicing method: demosaicing can be simplified by the known method of superimposing 4 neighbouring pixels,
the noise reduction parameters: an average span is used, for example 64 pixels,

Below the second threshold of lighting, an image of 100,000 pixels is expected:

the maximum value of a digital zoom: for use in small size, the digital zoom is limited to the square root of (4,000,000/100,000), i.e. approx. 6,
the exposure time can be fixed at 1/15 for varying sensitivities from 100 to 3200 ISO, then increasing above 3200 ISO,
the sensitivity can vary between 100 and 3200 ISO,
the size of the raw image is fixed at 4 times the number of pixels for use, 4,000,000 pixels in the example,
the demosaicing method: demosaicing can be simplified by the known method of superimposing 4 neighbouring pixels,
the noise reduction parameters: a larger span is used, for example 256 pixels,
the sharpness parameters: a smaller filter is used, for example 3×3.

In the same manner, for use in standard size, lighting can be taken into account in order to use the parameters corresponding to use in small size, if the lighting is below the second threshold.

In a device using the invention, the image resolution is automatically reduced when the lighting is reduced below a certain threshold.

Use with at Least Two Services

In an embodiment, at least two types of multimedia data are acquired for providing at least two services, the specifications of each multimedia data being adapted to the corresponding service.

Such embodiment is more particularly adapted to the case where one wishes to embody a use in two separate sizes, for example:

small and standard: such case corresponds, for example, to the services, for a mobile terminal, for sending to a mobile telephone and for sending to an e-mail/printer/postcard.

standard and maximum: such case corresponds, for example, for a camera, to the services, on the one hand, for standard printing or use on a computer and, on the other, for enlargement.

Usually, an image is acquired for the maximum size and then the image size is reduced. In such embodiment, two images are acquired, the picture-taking parameters for each image being adapted to each use in order to optimise the image quality during each use. Thus, in low lighting, the using the smallest size will have an improved quality in relation to more common methods.

For example, if both standard size and small size are required, the picture-taking parameters for each picture can be determined in the following manner:

Image for use in standard size:

the exposure time can be fixed at 1/60 for varying sensitivities from 100 to 800 ISO, then increasing above 800 ISO,
the sensitivity can vary between 100 and 800 ISO,
the size of the raw image is fixed at 4 times the number of pixels for use, 4,000,000 pixels in the example,
the demosaicing method: demosaicing can be simplified by the known method of superimposing 4 neighbouring pixels,
the noise reduction parameters: an average span is used, for example 64 pixels,

Image for use in small size

the maximum value of a digital zoom: for use in small size, the digital zoom is limited to the square root of (4,000,000/100,000), i.e. approx. 6,
the exposure time can be fixed at 1/15 for varying sensitivities from 100 to 3200 ISO, then increasing above 3200 ISO,
the sensitivity can vary between 100 and 3200 ISO,
the size of the raw image is fixed at 4 times the number of pixels for use, 400,000 pixels in the example,
the demosaicing method: demosaicing can be simplified by the known method of superimposing 4 neighbouring pixels,
the noise reduction parameters: an larger span is used, for example 256 pixels,
the sharpness parameters: a larger filter is used, for example 3×3.

FIG. 11 illustrates in a very simple manner, these characteristics of the invention. When the photographic device of a photophone 200 takes a photograph destined to a printing service 202, as indicated by the user by way of a corresponding menu, the exposure time is automatically determined at 1/60^{th} of a second in order to minimise the risk of movement blurring. When the user of the photophone 200 indicates that the photograph to be taken 204 is destined to be displayed on the screen 206 of the photophone 200, then the maximum exposure time is limited to 1/15^{th} of a second because on the small-size screen, the movement blurring is less sensitive. Finally, when the amount of lighting for the scene is lower than a first threshold, the characteristics of the photography 202 are adapted: 4 times less pixels and more noise reduction in order to make the photography usable, even if the detail is reduced.

Furthermore, if the user has indicated, in a corresponding menu, that he wishes to use the photo for the two services, i.e. sending towards a printing service 202 and displaying on the screen 206, if the optimal picture-taking parameters are different for these two services, the photographic device will take two successive pictures, each one being optimised for the corresponding service.

It should be noted that these characteristics are, as indicated above, applicable to all picture-taking device, namely of the photo or video type. Thus, the picture-taking parameters can be adapted to the end use:

the parameters optimised for viewing on a device for displaying on a screen not being, for example, the same as the parameters optimised for an enlargement,

the parameters optimised for viewing an image taken in low lighting on a printer not being the same as the parameters optimised for viewing an image taken in good lighting on a printer.

1-26. (canceled)

27. A method to improve quality of using at least one service relating to at least one type of multimedia data, the multimedia data being an image stemming from an image acquisition device and the service corresponding to a use of the determined image; the method comprising:
automatically determining at least one picture-taking parameter according to the service, so that, for example, an image destined to a mobile telephone may benefit from a longer exposure time than for an image destined to a printing service, or to be visualized on a computer screen.

28. A method according to claim 27, further comprising providing an indication of the image's end use; the indication of the image's end use being provided in a form of a number of pixels necessary for the use and/or in a form of a type of image restitution device.

29. A method according to claim 27, further comprising providing an indication of the image's end use; the indication of the image's end use being made when creating a message for a particular service, and/or via an adjustment performed by the user of the device, and/or via an adjustment performed by the service operator.

30. A method according to claim 27 in which the image is a raw image.

31. A method according to claim 27 in which at least one picture-taking parameter is automatically determined according to the service and to an amount of lighting.

32. A method according to claim 27 in which the multimedia data is an image acquired for providing at least two services, characteristics of such image being the picture-taking parameters automatically determined according to at least one of the two services and to an amount of lighting during the picture taking, so that, particularly in low lighting, the image can be used for at least one of the two services.

33. A method according to claim 27 in which at least two types of multimedia data are acquired for providing at least two services, characteristics of each type of multimedia data being adapted to the corresponding service.

34. A method according to claim 27, further comprising providing automatic assistance to the terminal user to acquire the multimedia data, particularly through assistance with the image framing and/or with verifying the quality of such image, by providing acquisition lessons or instructions and/or adjustments, or by displaying the final result of the acquisition.

35. A method according to claim 27 in which the multimedia data is an image stemming from an image acquisition device including a sensor, the image acquisition including all or part of:
servo-control exposure prior to picture-taking,
image acquisition using all or part of the sensor, according to a digital zoom,
image dematrixing,
noise reduction,
increase in sharpness;
and the picture-taking parameters are determined to optimize the image for a determined type of use according to the service.

36. A method according to claim 35 in which the type of use for the service is chosen among: a use of the image in small size, a use of the image in standard size, and a use of the image in maximum size,
and each type of use is characterized by a number of necessary pixels.

37. A method according to claim 35 further comprising adapting a digital zoom depending on the use, by calculating a maximum zoom factor, such as the number of pixels acquired being close to the number of pixels necessary for use.

38. A method according to claim 35 in which the adapting the servo-control exposure of the image acquisition device is performed depending on the type of use, for example by adjusting an exposure time and/or an aperture and/or the sensor gain included in the device.

39. A method according to claim 35, in which the adapting the number of acquired pixels is carried out depending on the type of use.

40. A method according to claim 35 in which the dematrixing is performed depending on the type of use.

41. A method according to claim 35 in which the noise reduction is performed depending on the type of use.

42. A method according to claim 35 in which the increasing the sharpness is performed depending on the type of use.

43. A method according to claim 35 in which, for use in maximum size, the image size is reduced below a lighting threshold.

44. A mobile telephone terminal, to improve quality of using at least one service relating to at least one type of multimedia data, the multimedia data being an image stemming from an image acquisition device, the service corresponding to a use of the determined image; the terminal comprising:
means for determining at least one picture-taking parameter according to the service, so that, for example, an image destined to a mobile telephone may benefit from a longer exposure time than for an image destined to a printing service or to be visualized on a computer screen.

45. A terminal according to claim 44, further comprising means for providing an indication of the image's end use; the indication of the image's end use being provided in a form of a number of pixels necessary for use and/or in a form of a type of image restitution device.

46. A terminal according to claim 44, further comprising means for providing an indication of the image's end use; the indication of the image's end use being made during creation of a message for a particular service, and/or via an adjustment performed by the user of the device, and/or via an adjustment performed by the service operator.

47. A terminal according to claim 44, further comprising means for automatically determining at least one picture-taking parameter according to the service and to the amount of lighting of the pictured scene.

48. A terminal according to claim 44, further comprising means for acquiring an image in view of providing at least two services, and means so that the characteristics of such image are the picture-taking parameters automatically determined according to at least one of the two services and the amount of lighting during the picture taking, so that, particularly in low lighting, the image can be used for at least one of the two services.

49. A terminal according to claim 44, further comprising means for acquiring an image in view of providing at least two services, and so that characteristics of each multimedia data is adapted to the corresponding service.

50. A terminal according to claim 44, further comprising means for providing automatic assistance to the terminal user to acquire the multimedia data, particularly by assisting with framing of an image and/or with verifying the quality of such image by providing acquisition lessons or instructions and/or adjustments, or by displaying a final result of the acquisition.

51. A terminal according to claim 44, further comprising means for determining the picture-taking parameters to optimize the image for a type of determined use according to a service, such type of use being chosen among: a use of the image in small size, a use of the image in standard size, and a use of the image in maximum size, and each type of use being characterised by a number of necessary pixels.

52. A terminal according to claim 44, further comprising means for carrying out one or plural of:
servo-control exposure prior to picture-taking depending on the use, image acquisition using all or part of the sensor, according to a digital zoom, depending on the use,
image dematrixing depending on the use,
noise reduction depending on the use,
increase in sharpness depending on the use.
